(19) United States
(12) Patent Application Publication
(10) Pub. No.: US 2026/0176717 A1
(43) Pub. Date: Jun. 25, 2026

(54) ZERO WASTE CLOSED-LOOP GREEN LITHIUM-ION BATTERY RECYCLING

(71) Applicant: American Advanced Membrane Technology LLC, Knoxville, TN (US)

(72) Inventor: Rachid Essehli, Knoxville, TN (US)

(21) Appl. No.: 19/415,290

(22) Filed: Dec. 10, 2025

Related U.S. Application Data
(60) Provisional application No. 63/737,198, filed on Dec. 20, 2024.

(51) Int. Cl. C22B 26/12; B01D 61/44; B01D 61/46; C01B 32/215; C01F 7/46; C01G 49/02; C22B 3/00; C22B 3/44; C22B 7/00; C22B 47/00; H01M 10/54

(52) U.S. Cl. CPC C22B 26/12; B01D 61/445; B01D 61/461; C01B 32/215; C01F 7/46; C01G 49/02; C22B 3/44; C22B 7/007; C22B 23/043; C22B 23/0461; C22B 47/0009; H01M 10/54

(57) ABSTRACT

A method for recycling catalytic metals comprising: collecting a plurality of spent catalytic metals, wherein the spent catalytic metals contain cathodes of NMC111, NMC622, NMC811, NCA, LCoO₂, LiNi0.5Mn1.5O₄, LiMnO₄, LiNiO₂, LiMn₂O₄, and/or LiMnO₂ compositions; subjecting the plurality of spent catalytic metals to a green mixture, wherein the green mixture includes dihydrogen phosphite and water, phosphoric acid and water, sulfuric acid and water, hydrogen chloride and water, or nitric acid and water, at temperatures of between 80 and 120° C. to form a metal leachate solution; and recovering lithium (Li) from the metal leachate solution.

### CROSS REFERENCE TO RELATED APPLICATIONS

This application claims the priority benefit of U.S. Provisional Patent Application No. 63/737,198, filed Dec. 20, 2024, which is hereby incorporated herein by reference in its entirety.

### BACKGROUND

The increasing use of lithium-ion batteries (LIBs) in various applications has led to a growing concern about the efficient recycling of spent batteries and the recovery of valuable metals, including lithium, cobalt, nickel, and other components. Traditional recycling methods involving inorganic acid leaching have limitations such as environmental impact, slow processing, low product purity, and the use of environmentally harmful chemicals. Therefore, there is a need in the art for a recycling process that reduces costs and energy consumption associated with traditional metal extraction methods.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 shows an exemplary closed loop version of the recycling process of the present disclosure.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

The present disclosure pertains to a zero-waste and energy-efficient process for recycling spent catalytic metals. Within the context of the present disclosure, catalytic metals include lithium-ion batteries, nickel-based catalysts, or nickel-containing mineral ores. In one or more versions, this process may dissolve the spent catalytic metals and individually recover high-purity materials such as nickel, cobalt, manganese, and lithium without using any organic solvent, which may offer advantages over conventional organic solvent-extraction processes with zero Na₂SO₄ as a bioproduct. This environmentally friendly process may prevent landfill disposal and minimizes the release of hazardous chemicals, protecting both ecosystems and public health. Unlike traditional recycling methods, this process may generate useful byproducts for applications in other industries, supporting a circular economy. Through this closed-loop solution in catalytic metal recycling and production, the present disclosure provides a process that safeguards the environment and promotes sustainable technological advancement.

The present disclosure provides a process for recycling catalytic metals, such as spent lithium-ion batteries, utilizing a modified hydrometallurgy method, which is efficient, facile, low-cost, and environmentally friendly. Furthermore, the process of the present disclosure does not lead to toxic waste. The resulting products produced by the process of the present disclosure are separated nickel, manganese, cobalt, and lithium that can then be reused in, for example, new lithium-ion batteries.

The process of the present disclosure introduces a green method for recovering metals from a catalytic metal waste stream that overcomes the drawbacks of conventional recycling. This process of the present disclosure may be sustainable, low in carbon emissions, efficient, cost-effective, and environmentally friendly. The process of the present disclosure may achieve closed-loop recycling with high leaching efficiency and straightforward separation processes. Valuable metals including Nickle (Ni), Cobalt (Co), Manganese (Mn), and Lithium (Li) can be extracted with remarkable efficiency rates of up to 99.9%.

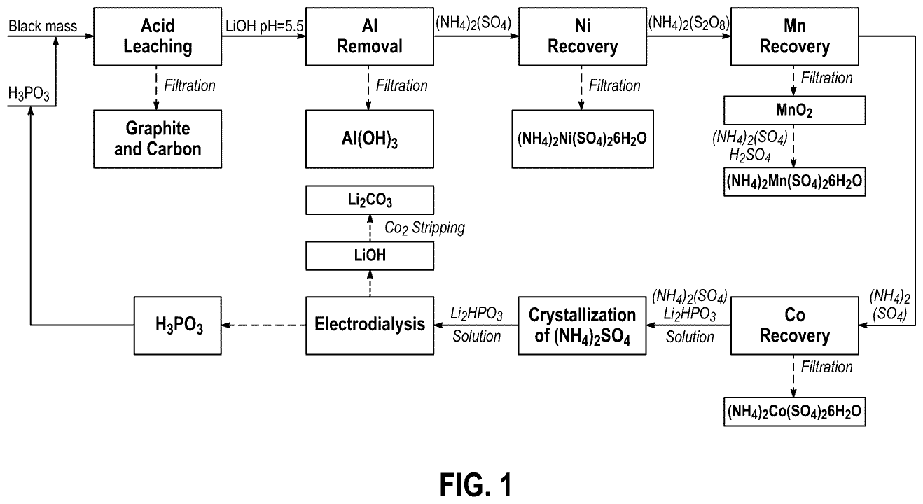

Other advantages of the process of the present disclosure may be the individual recovery of Nickel (Ni) from a Cobalt (Co) and Manganese (Mn) mixture without using any organic solvent offering advantages over conventional organic solvent-extraction processes. In a further aspect of the process of the present disclosure, a separation efficiency for each of cobalt (Co), Nickle (Ni), and manganese (Mn) may be greater than or equal to about 99.5˜99.7%, respectively. In one version of the process of the present disclosure, the increasing of the pH of the filtrate liquid stream comprises first adding for example (NH₄)₂SO₄ as a co-precipitation agent to the formation of (NH₄)₂M(SO₄)₂·nH₂O, wherein M may represent nickel (II) cation, cobalt (II) cation, manganese (II) cation, or combinations thereof and n may be 1<n<10 with a high impurity of 99.5˜99.7%. One version of the process of the present disclosure is shown in FIG. 1.

In one version of the process of the present disclosure, metals, such as nickel, manganese, cobalt, and lithium, may be leached from the catalytic metals, such as spent cathodes from LIBs. In one or more versions, the spent cathodes from the LIBs may contain NMC111, NMC622, NMC811, NCA, LCoO₂, LiNi_{0.5}Mn_{1.5}O₄, LiMnO₄, LiNiO₂, LiMn₂O₄, and/or LiMnO₂ compositions, as well variations of lithium nickel oxides, lithium nickel manganese oxides, lithium nickel manganese cobalt oxides, and lithiated nickel-cobalt aluminum oxides. In one or more versions, lithiated nickel-cobalt aluminum oxides may be represented by the general formula Li [NiₓCo_{y}Al_{z}] 02+r; wherein x may be in the range of 0.8 to 0.9, y may be in the range of 0.15 to 0.19, x may be in the range of 0.01 to 0.05, and r may be in the range of 0.0 to 0.4. In one or more versions, the feedstock may also comprise any nickel-based catalysts or nickel-containing mineral ores, providing a broad range of nickel-rich materials suitable for hydrometallurgical or electrochemical recovery processes, nickel stripping solutions and also to be reused in rechargeable alkaline batteries.

In a first Example, the first step of the process may be to leach nickel, manganese, cobalt, and lithium from the spent cathodes. A cathode leaching solution may be utilized in this step. In one or more versions, the cathode leaching solution may be a 2 mol/l concentration of phosphorous acid (H₃PO₃). In yet other embodiments, the cathode leaching solution may be selected from phosphoric acid and water, sulfuric acid and water, hydrogen chloride and water, or nitric acid and water. The spent cathodes may be added directly into the cathode leaching solution and the spent cathodes and cathode leaching solution may then be stirred at a temperature of between about 80 and 120° C. for about an hour. After about an hour, unreacted carbon black films and graphite may be left behind, which may then be trapped and removed by a filtration unit, allowing the leached metals solution to remain.

In a next step of the process of the present disclosure, removal of impurities from the cathode leaching solution may take place. The step may occur by adding a basic solution to the solution. In one or more versions, the basic solution may be LiOH, NaOH, KOH, or combinations thereof and it may be added at about a concentration of 0.1M. The basic solution may be added to slowly increase the solution pH to precipitate Al³⁺ and Fe³⁺ ions as aluminum hydroxide Al(OH)₃ and iron hydroxide Fe(OH)₃. Fe³⁺ and Al³⁺ may then begin to precipitate out of solution at relatively low pH˜3 to 5, while other metals remain in the solution.

In a next step of the process, co-precipitation may take place. Nickel may be precipitated out at room temperature by adding an inorganic salt, such as but not limited to ammonium sulfate (NH₄)₂SO₄) or NH₄ASO₄ wherein A equals H, Na, K, Rb, Cs, or Li as a co-precipitate agent, which may react to form pure ammonium Nickel (ii) sulfate hexahydrate ((NH₄), Ni(SO₄)₂·nH₂O)) wherein n is an integer from 2 to 10. The ammonium Nickel (ii) sulfate hexahydrate can then be filtered and separated from the mixture using a customized reactor, which may combine the dual functions of the Leaching unit and the filter. The filter may trap the (NH₄)₂Ni(SO₄)₂·6H₂O) particles, allowing the purified salt solution to pass through as shown in FIG. 1.

In a second Example, the first step of the process may be to leach nickel, manganese, cobalt, and lithium from the spent cathodes. A cathode leaching solution may be utilized in this step. In one or more versions, the cathode leaching solution may be a 2 mol/L concentration of sulfuric acid (H₂SO₄). In other embodiments, the cathode leaching solution may be selected from phosphorous acid and water, phosphoric acid and water, hydrogen chloride and water, or nitric acid and water. The spent cathodes may be added directly into the cathode leaching solution, and the mixture may then be stirred at a temperature of between about 80 and 120° C. for about an hour. After about an hour, unreacted carbon black films and graphite may remain, which may then be captured and removed using a filtration unit, allowing the leached metals solution to pass through.

In a further step in the process, impurities may be removed from the cathode leaching solution. This may occur by adding a basic solution to adjust the pH. In one or more versions, the basic solution may be LiOH, NaOH, KOH, or combinations thereof, at a concentration of about 0.1 M. The basic solution may be added gradually to raise the solution pH and precipitate Al³⁺ and Fe³⁺ ions as aluminum hydroxide Al(OH)₃ and iron hydroxide Fe(OH)₃·Al³⁺ and Fe³⁺ may begin to precipitate at relatively low pH values (approximately 3 to 5), while the other metals remain dissolved.

In a further step in the process, co-precipitation may take place. Nickel may be selectively precipitated at room temperature by adding an inorganic salt—such as, but not limited to, ammonium sulfate ((NH)₂SO₄), NH4Cl or NH₄ASO₄ (A=H, Na, K, Rb, Cs, or Li)—as a co-precipitating agent. These reagents may react to form pure ammonium nickel (II) sulfate hexahydrate ((NH₄)₂Ni(SO₄)₂·nH₂O), wherein n is an integer from 2 to 10. The resulting ammonium nickel (II) sulfate hexahydrate can then be filtered and separated using a customized reactor that integrates both leaching and filtration functions. The filter may trap the (NH₄)₂Ni(SO₄)₂·6H₂O crystals

The remaining metals form a first metal solution consisting of manganese (Mn), cobalt (Co), and Lithium (Li), and the first metal solution may then be moved to a new tank. In a next step, an oxidizing agent, such as but not limited to ammonium persulfate, sodium persulfate, or potassium persulfate may be introduced at a temperature of about 80° C. to precipitate manganese. The oxidizing agent may oxidize the manganese through the reaction: Mn²⁺+S₂O₈²⁻+2H₂O→MnO₂+2SO₄²⁻+4H⁺·MnO₂ may then be filtrated and separated. MnO₂ is a valuable precipitate that can have various applications, including as a component in battery cathodes, water treatment processes, and as a catalyst in certain chemical reactions. The remaining metals from a second metal solution consisting of cobalt and lithium salts may then subsequently be maintained at a temperature from about room temperature to about 45° C., where the co-precipitation of Co as ((NH₄)2Co(SO₄)2·6H₂O) may occur by adding an excess of an inorganic salt, such as but not limited to ammonium sulfate (NH₄)₂SO₄) or NH₄ASO₄ wherein A equals H, Na, K, Rb, Cs, Li, or NH₄Cl. The remaining solution contains mostly Li₂HPO₃ and some traces of Li₂SO₄. The remaining solution may then be maintained at about 60° C. to crystallize and precipitate ammonium sulfate. It is worth noting that the crystallized ammonium sulfate obtained at this stage can be reused for subsequent co-precipitation processes, thus further decreasing the waste associated with spent cathode recycling process of the present disclosure.

In the next step of the process of the present disclosure, lithium hydroxide recovery may occur through a bipolar membrane electrodialysis process (BMED). BMED may be employed to recover LiOH and H₃PO₃ solutions from Li₂HPO₃ solution obtained from the recycling process. In one or more versions, a series of experiments could be performed under varying electrical currents to identify the optimal current for subsequent investigations. To examine the impact of current density on the separation and recovery of LiOH and H₃PO₃ solutions from the Li₂HPO₃ solution, the BMED stack consisting of four cell pairs could be employed. Three different current levels, namely 5 A, 10 A, and 15 A, could be tested, corresponding to current densities of 400 A/m², 800 A/m², and 1200 A/m², respectively.

When the leaching solution contains phosphorous acid (H₃PO₃), after impurity removal and metal extraction as discussed above, the solution that remains behind contains mostly Li₂HPO₃ (with minor traces of Li₂SO₄). However, when leaching solution contains (H₂SO₄), after impurity removal and metal extraction, the solution that remains behind contains mostly Li₂SO₄. A three-compartment electrodialysis cell may be employed to regenerate LiOH and H₃PO₃ from the Li₂HPO₃ solution or LiOH and H₂SO₄ from the Li₂SO₄ solution. During electrodialysis, Lit ions may migrate from a central compartment toward a cathode compartment of the three-compartment electrodialysis cell and (HPO₃)²⁻ may migrate from the central compartment toward an anode compartment of the three-compartment electrodialysis cell under the influence of an electric field. In the cathode compartment, water may then be reduced to produce OH— and H₂·Li+ may migrate across the membrane of the BMED into the cathode compartment to neutralize the OH— charge to form LiOH. In one or more versions, the pH of the LiOH solution may be about from 9 to 12. In one or more versions, the pH was found to be 11.85. In one or more versions, Li may be recovered as LiOH.

In the anode compartment, water may be oxidized to form O₂ gas and H⁺ protons. The (HPO₃)²⁻ ions may diffuse from the central compartment through the membrane to the anolyte of the electrodialysis anode compartment and may join with the protons generated within the anode compartment and may then form H₃PO₃. In one or more versions, the pH within the anode compartment is about 0.5. The formed H₃PO₃ can then be reused for subsequent leaching processes.

In a final step of the process of the present disclosure, lithium carbonate is produced from the formed LiOH. In one or more versions, a CO, stripping device may be utilized during this step. The CO₂ stripping process helps enhance lithium recovery efficiency by driving the reaction that precipitates lithium carbonate from the solution. Once CO, is effectively stripped, a small-scale evaporator may be utilized to concentrate the lithium-containing solution. This step allows for the precipitation of lithium carbonate (Li₂CO₃) from the concentrated solution. By carefully controlling the evaporation step, the process of the present disclosure may be able to achieve optimal crystallization conditions, resulting in the formation of high-purity lithium carbonate.

In one or more versions of the process of the present disclosure, high recovery efficiency was shown. In one version, a high recovery efficiency of between about 93% and 99.9% was shown. In yet another version, a high recovery efficiency of about 95% for metals as (NH₄)2M(SO₄)2·6H₂O (where M=Ni, Mn, Co) and about 94.3% of LiOH·H₂O recovery by electrodialysis from a high Nickle black mass, containing 32.505% of Ni, 1.453% of Co, and 1.036% of Mn. Based on 1 kg of this cathode material, the process of the present disclosure got 1.65 kg of (NH₄)₂Ni(SO₄)₂·6H₂O, 78 g of (NH₄)2Co(SO₄)2·6H₂O, 65 g of (NH₄)2Mn(SO₄)2·6H₂O, and about 0.3 kg of LiOH·H₂O.

The x-ray diffraction pattern of (NH₄)₂Ni(SO₄)₂·6H₂O recovered from the process described above is shown in FIG. 3. The pattern shows a pure phase of (NH₄)₂Ni(SO₄)₂·6H₂O. No secondary impurities can be observed, indicating a homogenous sample. The samples containing cobalt and manganese were also analyzed and exhibited pure phases.

### Illustrative Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A method for recycling catalytic metals comprising: collecting a plurality of spent catalytic metals, wherein the spent catalytic metals contain cathodes of NMC111, NMC622, NMC811, NCA, LCoO₂, LiNi0.5Mn1.5O₄, LiMnO₄, LiNiO₂, LiMn₂O₄, and/or LiMnO₂ compositions; subjecting the plurality of spent catalytic metals to a green mixture, wherein the green mixture includes dihydrogen phosphite and water, phosphoric acid and water, sulfuric acid and water, hydrogen chloride and water, or nitric acid and water, at temperatures of between 8° and 120° C. to form a metal leachate solution; and recovering lithium (Li) from the metal leachate solution.

### Example 2

The method of Example 1, wherein the catalytic metals include lithium-ion batteries, nickel-based catalysts, or nickel-containing mineral ores.

### Example 3

The method of Example 1, wherein after the step of subjecting the plurality of spent catalytic metals to a green mixture, unreacted carbon black films and graphite may be formed.

### Example 4

The method of Example 3, further comprising separating any unreacted carbon black films and graphite from the metal leachate solution and maintaining the metal leachate solution at room temperature.

### Example 5

The method of Example 4, wherein the unreacted carbon black films and graphite may be separated from the metal leachate solution by a filtration unit.

### Example 6

The method of Example 4, further comprising increasing the pH of the metal leachate solution with a basic solution, wherein the basic solution is LiOH, NaOH, KOH, or combinations thereof, and wherein the basic solution is added at a concentration of about 0.1M to precipitated aluminum hydroxide Al(OH)₃ and iron hydroxide Fe(OH)₃.

### Example 7

The method of Example 6, further comprising separating the precipitated Al(OH)₃ and Fe(OH)₃ from the metal leachate solution and maintaining the metal leachate solution at room temperature.

### Example 8

The method of Example 7, further comprising the addition of an inorganic salt to the metal leachate solution to facilitate co-precipitation, and wherein the inorganic salt is at least one of (NH₄)2SO₄ or (NH₄)ASO₄ where A is H, Na, K, Rb, Cs, Li, or NH₄Cl.

### Example 9

The method of Example 8, wherein the addition of the inorganic salt forms an ammonium Nickle(ii) sulfate hexahydrate ((NH₄)2Ni(SO₄)2·6H₂O).

### Example 10

The method of Example 9, further comprising separating the ammonium Nickle (ii) sulfate hexahydrate ((NH4)2Ni(SO₄)2·6H2O) to form a first remaining metal solution consisting of manganese (Mn), cobalt (Co), and Lithium (Li).

### Example 11

The method of Example 10, further comprising the addition of an oxidizing agent to the first remaining metal solution at a temperature of between 8° and 120° C. to precipitate manganese, once the manganese is removed, a second remaining metal solution consisting of cobalt (Co) and Lithium (Li) is formed.

### Example 12

The method of Example 11, wherein the oxidizing agent is selected from ammonium persulfate, sodium persulfate, or potassium persulfate.

### Example 13

The method of Example 12, further comprising the addition of an inorganic salt to the second remaining metal solution at a temperature of about 45° C. to precipitate cobalt, once the cobalt is removed, a lithium (Li) solution of Li₂HPO₃ and some traces of Li₂SO₄ remains.

### Example 14

The method of Example 13, wherein the inorganic salt is selected from ammonium sulfate (NH₄)₂SO₄) or NH₄ASO₄ wherein A equals H, Na, K, Rb, Cs, Li, or NH₄Cl.

### Example 15

The method of Example 14, wherein the step of recovering Li includes feeding the lithium solution to a bipolar electrodialysis cell which regenerates LiOH and H₃PO₃.

### Example 16

The method of Example 15, wherein the bipolar electrodialysis cell includes a central compartment, a cathode compartment, and an anode compartment such that during electrodialysis, Li⁺ ions migrate from the central compartment toward the cathode compartment and (HPO₃)²⁻ ions migrate from the central compartment toward the anode compartment.

It should be understood that any of the versions of catalytic metal recycling systems and methods described herein may include various other features in addition to or in lieu of those described above. By way of example only, any of the catalytic metal recycling systems and methods described herein may also include one or more of the various features disclosed in any of the various references that are incorporated by reference herein. It should also be understood that the teachings herein may be readily applied to any of the catalytic metal recycling systems and methods described in any of the other references cited herein, such that the teachings herein may be readily combined with the teachings of any of the references cited herein in numerous ways. Moreover, those of ordinary skill in the art will recognize that various teachings herein may be readily applied to other versions of catalytic metal recycling systems and methods outside of the versions shown in the drawings. Other types of catalytic metal recycling systems and methods into which the teachings herein may be incorporated will be apparent to those of ordinary skill in the art. Another benefit of the disclosed method may be its avoidance of sodium sulfate (Na₂SO₄) byproduct generation. This not only may eliminate considerable waste but may also mitigate the embedded emissions associated with the consumption of chemicals.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present disclosure should be considered in terms of the following claims and is understood not to be limited to the details of structure and operation shown and described in the specification and drawings.

What is claimed is:

1. A method for recycling catalytic metals, comprising:
a. collecting a plurality of spent catalytic metals, wherein the spent catalytic metals contain cathodes of NMC111, NMC622, NMC811, NCA, LCoO₂, LiNi0.5Mn1.5O₄, LiMnO₄, LiNiO₂, LiMn₂O₄, and/or LiMnO₂ compositions;
b. subjecting the plurality of spent catalytic metals to a green mixture, wherein the green mixture includes dihydrogen phosphite and water, phosphoric acid and water, sulfuric acid and water, hydrogen chloride and water, or nitric acid and water, at temperatures of between 80 and 120° C. to form a metal leachate solution; and
c. recovering lithium (Li) from the metal leachate solution.

2. The method of claim 1, wherein the catalytic metals include lithium-ion batteries, nickel-based catalysts, or nickel-containing mineral ores.

3. The method of claim 1, wherein after the step of subjecting the plurality of spent catalytic metals to a green mixture, unreacted carbon black films and graphite may be formed.

4. The method of claim 3, further comprising separating any unreacted carbon black films and graphite from the metal leachate solution and maintaining the metal leachate solution at room temperature.

5. The method of claim 4, wherein the unreacted carbon black films and graphite may be separated from the metal leachate solution by a filtration unit.

6. The method of claim 4, further comprising increasing the pH of the metal leachate solution with a basic solution, wherein the basic solution is LiOH, NaOH, KOH, or combinations thereof, and wherein the basic solution is added at a concentration of about 0.1M to precipitated aluminum hydroxide Al(OH)₃ and iron hydroxide Fe(OH)₃.

7. The method of claim 6, further comprising separating the precipitated Al(OH)₃ and Fe(OH)₃ from the metal leachate solution and maintaining the metal leachate solution at room temperature.

8. The method of claim 7, further comprising the addition of an inorganic salt to the metal leachate solution to facilitate co-precipitation, and wherein the inorganic salt is at least one of (NH₄)2SO₄ or (NH₄) ASO₄ where A is H, Na, K, Rb, Cs, Li, or NH₄Cl.

9. The method of claim 8, wherein the addition of the inorganic salt forms an ammonium Nickle (ii) sulfate hexahydrate ((NH₄)2Ni(SO₄)2·6H₂O).

10. The method of claim 9, further comprising separating the ammonium Nickle (ii) sulfate hexahydrate ((NH4)2Ni(SO4)2·6H2O) to form a first remaining metal solution consisting of manganese (Mn), cobalt (Co), and Lithium (Li).

11. The method of claim 9, further comprising the addition of an oxidizing agent to the first remaining metal solution at a temperature of between 8° and 120° C. to precipitate manganese, once the manganese is removed, a second remaining metal solution consisting of cobalt (Co) and Lithium (Li) is formed.

12. The method of claim 11, wherein the oxidizing agent is selected from ammonium persulfate, sodium persulfate, or potassium persulfate.

13. The method of claim 12, further comprising the addition of an inorganic salt to the second remaining metal solution at a temperature of about 45° C. to precipitate cobalt, once the cobalt is removed, a lithium (Li) solution of Li₂HPO₃ and some traces of Li₂SO₄ remains.

14. The method of claim 13, wherein the inorganic salt is selected from ammonium sulfate (NH₄)₂SO₄) or NH₄ASO₄ wherein A equals H, Na, K, Rb, Cs, Li, or NH₄Cl.

15. The method of claim 14, wherein the step of recovering Li includes feeding the lithium solution to a bipolar electrodialysis cell which regenerates LiOH and H₃PO₃.

16. The method of claim 15, wherein the bipolar electrodialysis cell includes a central compartment, a cathode compartment, and an anode compartment such that during electrodialysis, Li⁺ ions migrate from the central compartment toward the cathode compartment and (HPO₃)²⁻ ions migrate from the central compartment toward the anode compartment.
